(19) United States
(12) Patent Application Publication
(10) Pub. No.: US 2005/0102326 A1
(43) Pub. Date: May 12, 2005

(54) Method and apparatus for performing conflict resolution in database logging

(76) Inventors: Nitzan Peleg, Haifa (IL); Edward Bortnikov, Haifa (IL); Dror Zernik, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/691,175

(22) Filed: Oct. 22, 2003

(51) Int. Cl. G06F 17/30

(52) U.S. Cl. 707/200; 707/100

(57) ABSTRACT

The disclosed embodiments relate to a system and method for performing conflict resolution when refreshing a materialized view. The system may comprise a logging mechanism that maintains a refresh log, the refresh log may contain a first range and a second range that at least partially overlap, the first range and the second range each having a timestamp associated therewith. The system may also include a refresh manager that resolves conflicts between the first range and the second range that at least partially overlap by selecting portions of the first range and the second range that have the more recent timestamp and applying the selected portions of the first range and the second range to the materialized view. In another embodiment, the system may comprise a logging mechanism that maintains a refresh log, the refresh log containing a range and a single-row entry, the range and the single row entry each having a timestamp associated therewith. The system may also include a refresh manager that resolves conflicts between the range and the single-row entry by ignoring the single-row entry if the single-row entry is part of the range and if the single-row entry has the more recent timestamp and by applying the single-row entry to the materialized view if the single-row entry is not part of the range or if the range has the more recent timestamp.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modern computer databases may store immense amounts of data. This data is typically stored in one or more tables that comprise the database. If a database contains large amounts of data, it may take a relatively long time to perform a query to retrieve data that is of interest to a user. The time required for a database to respond to a query may have an adverse impact on the performance of the database as a whole. If the database is subject to a large number of complex queries, the response time for each query may be seriously lengthened. A query may identify a subset of elements of a table. The subset may be referred to as a “view.” If a view requires information from several tables or is frequently requested by users, the view may be created as a “materialized view” to improve the performance of the database. When a view is materialized, it may actually be stored as a separate table within the database. Queries may then be run against the materialized view without incurring processing time penalties for reassembling the information contained in the materialized view each time a query that may be satisfied by the materialized view is performed.

In order to make sure that the integrity of data provided by a database is maintained, the data stored in a materialized view may need to be updated when the underlying data in the base tables that affect the materialized view is changed. When changes to underlying base tables occur, the database management system (“DBMS”) may create and/or update a log showing the changes. Periodically, the DBMS may use the information contained in the log to update or refresh a materialized view.

In a complex database environment, either immediate refreshing or deferred refreshing may be employed. Immediate refreshing refers to a policy in which materialized views are updated after every change to an underlying base table. In many cases, immediate refreshing is not practical because it requires a lot of system overhead. For a deferred refresh policy, updates are collected in a log and applied periodically. Log entries may relate to either a single table entry or a range of entries. When updating a table based on the contents of the log, care must be taken to ensure that inconsistencies in the logged data do not result in the writing of erroneous data into the associated table.

Automatic range logging might introduce correctness problems to the log. There are two types of logging correctness issues that may require resolution. The first issue relates to conflicts between the range records and the second issue relates to conflicts between the single-row records and the range records. A method and apparatus that promotes effective range logging and may provide other advantages is desirable.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with embodiments of the present invention;

FIG. 2 is a block diagram illustrating a materialized view underlying table update log that may be implemented in embodiments of the present invention.

FIG. 3 is a block diagram showing a system that may perform logging and conflict resolution in accordance with embodiments of the present invention;

FIG. 4 is a block diagram that illustrates conflict resolution rules in accordance with embodiments of the present invention;

FIG. 5 is a schematic diagram that illustrates a first example of duplicate elimination with ranges in accordance with embodiments of the present invention; and

FIG. 6 is a schematic diagram that illustrates a second example of duplicate elimination with ranges in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

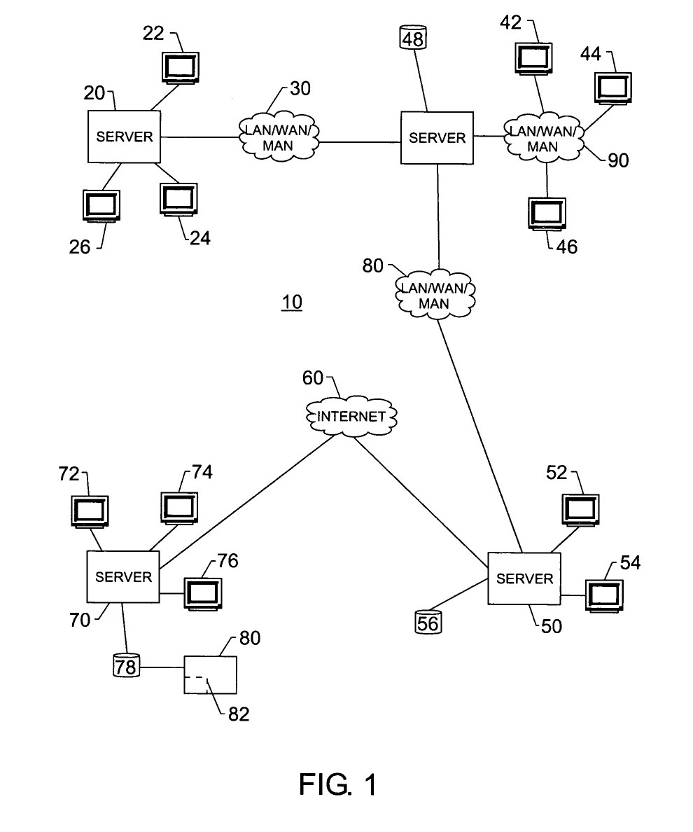

Turning now to the drawings and referring initially to FIG. 1, a block diagram of a computer network architecture is illustrated and designated using a reference numeral 10. A server 20 may be connected to a plurality of client computers 22, 24 and 26. The server 20 may be connected to as many as “n” different client computers. Each client computer in the network 10 may be a functional client computer. The magnitude of “n” may be a function of the computing power or capacity of the server 20. The computing power or capacity of the server 20 may be a function of many design factors such as the number and speed of processors and/or the size of the system memory, for example.

The server 20 may be connected via a network infrastructure 30, which may include any combination of hubs, switches, routers, and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. A storage device 48 such as a hard drive, storage area network (“SAN”), RAID array or the like may be attached to the server 40. The storage device 48 may be used to store a database or portion of a database for use by other network resources. Portions or partitions of a single database may be stored on various different storage devices within the network 10.

The server 40 may be adapted to create log files for updating materialized views that may be stored on the storage device 48. For example, the server 40 may be adapted to identify Insert/Update or Delete operations made to base tables that affect the materialized view and create a log entry with a timestamp indicating when the operation to the base table occurred.

The server 40 may additionally be connected to server 50, which may be connected to client computers 52 and 54. A network infrastructure 80, which may include a LAN, a WAN, a MAN or other network configuration, which may be used to connect the client computers 52, 54 to the server 50. The number of client computers connected to the servers 40 and 50 may depend on the capacity of the servers 40 and 50 to process information. A storage device 56 such as a hard drive, storage area network (“SAN”), RAID array or the like may be attached to the server 50. The storage device 56 may be used to store a database or portion of a database for use by other network resources.

The server 50 may be adapted to create log files for updating materialized views that may be stored on the storage device 56. For example, the server 50 may be adapted to identify Insert/Update or Delete operations made to base tables that affect the materialized view and create a log entry with a timestamp indicating when the operation to the base table occurred.

The server 50 may additionally be connected to the Internet 60, which may be connected to a server 70. The server 70 may be connected to a plurality of client computers 72, 74 and 76. The server 70 may be connected to as many client computers as its computing capacity may allow. A storage device 78 such as a hard drive, storage area network (“SAN”), RAID array or the like may be attached to the server 40. The storage device 78 may be used to store a database 80 or portion of a database for use by other network resources. The database 80 may comprise a materialized view 82 (shown in dashed lines). Those of ordinary skill in the art will appreciate that other storage devices in the network 10 may store databases, which may include materialized views.

The server 70 may be adapted to create log files for updating materialized views that may be stored on the storage device 78 such as the materialized view 82. For example, the server 70 may be adapted to identify Insert/Update or Delete operations made to base tables that affect the materialized view and create a log entry with a timestamp indicating when the operation to the base table occurred.

Those of ordinary skill in the art will appreciate that the servers 20, 40, 50, and 70 may not be centrally located. Accordingly, the storage devices 48, 56 and 78 may also be at different locations. A network architecture, such as the network architecture 10, may typically result in a wide geographic distribution of computing and database resources.

The use of databases in a networked computing environment is an important tool in a modern business environment. A database may be described as a collection of related records or tuples of information or data. A relational database is a popular type of database. In a relational database, a structured set of tables or relations is defined. The tables may be populated with rows and columns of data. The entire collection of tables makes up a relational database.

A database may be accessed through an application program, which may be referred to as a database management system or “DBMS.” The DBMS typically performs database management functions. The DBMS may additionally allow users to add new data to the database or access data that is already stored in the database. An access to the database is typically referred to as a “query.” A query may be performed across an entire relational database and may request data from one or more tables within the database. The organization of the data requested by a query may be called a “view.” Views may not exist independently within the database, but may only exist as the output from a query.

In a networked computing environment, the information stored in a database may not all be in a centralized location. Portions of data in a single relational database may be stored on different servers on different network segments, or even in different cities or countries. To make processing the information faster, a relational database may be partitioned among a number of servers to allow parallel processing of queries. The use of materialized views may also make the processing of queries more efficient.

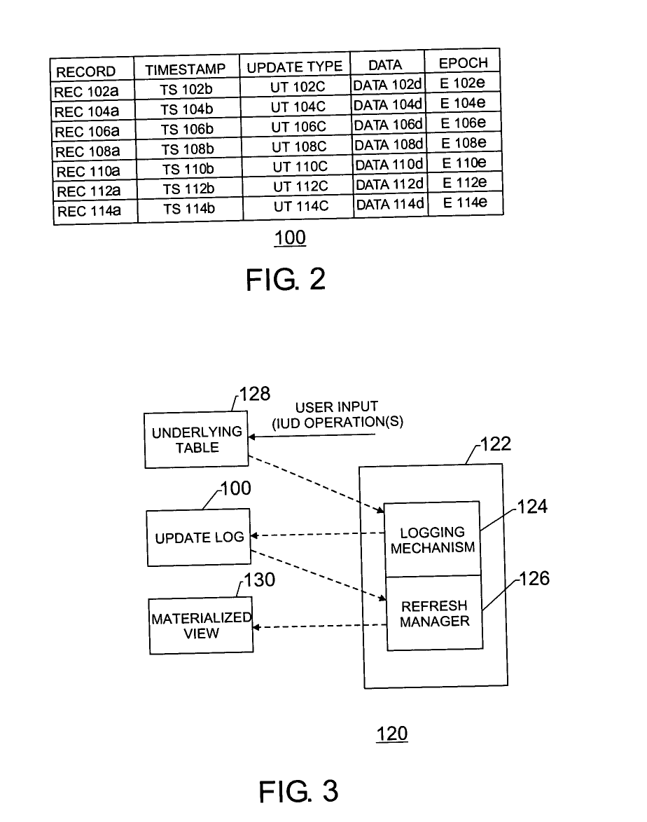

FIG. 2 is a block diagram illustrating a materialized view underlying table update log that may be implemented in embodiments of the present invention. When a materialized view is created, it may be designated to be refreshed according to one of two incremental refresh policies. Those policies may be referred to as a deferred refresh policy and an immediate refresh policy.

Database tables that have one or more materialized views defined on them and that employ a deferred refresh policy may automatically maintain a log similar to the log shown in FIG. 2. The refresh operations, including reading and updating the refresh log, may be performed by a part of the DBMS that may be referred to as a refresh manager. In FIG. 2, a partial excerpt of a refresh log is generally identified by the reference numeral 100. Because the refresh log contains information about Insert, Update and Delete operations, the refresh log may be referred to as an IUD log. The information shown in the log excerpt 100 is an example of the information that may be included in such a log. Those of ordinary skill in the art will appreciate that various combinations of data, including additional data or subsets of the data shown may exist in actual databases.

Each base table in a database may have its own IUD log. That log may serve all the deferred materialized views based on the base table. Accordingly, the IUD log for a particular table may be referred to as a T-log.

Each row of the IUD log 100 may constitute a separate record, which contains information about a change to the underlying table. The IUD log 100 may comprise a record column which may include an indication of the records that have been modified in a particular base table that contains data used in a particular materialized view. The record field identifies the base table row that was altered. In FIG. 2, the record column is populated with record identifiers 102a-114a, which may be primary keys. Those of ordinary skill in the art will appreciate that the IUD log 100 may contain multiple entries to the same base table row if that row has been altered more than once. A timestamp column contains timestamps indicative of the time at which the corresponding record in the base table was inserted, updated or deleted. The timestamps are identified by the reference numerals TS 102b-TS 114b in FIG. 2. As set forth above, the timestamps may not be correctly synchronized because they may have been generated by different nodes in a networked computing environment. In such a system, various components of a base table may be distributed in partitions that are located on a number of different computing nodes, as illustrated in FIG. 1.

The IUD log 100 may include an update type column that may contain data indicative of the type of update that was performed on the base table. The update type information may be useful in determining how to update associated materialized views when a refresh operation is performed. The update type column may contain an indication that a particular entry is to be ignored, as described below. The update type column in FIG. 2 is populated with data elements identified as UT 102c-UT 114c.

The refresh log or IUD log 100 may include a column indicative of the data that was added or modified in the base table row associated with the corresponding record identifier. These data elements are identified as data 102d-data 114d in FIG. 2.

Each row or record of the IUD log 100 may also include an epoch number. In FIG. 2, the epoch numbers for the rows shown are referred to as E 102e-E 114e. The epoch number may be used to identify a group of rows or records that have been added to the UD log 100 since a previous refresh operation was performed. A potential problem with refreshing materialized views may relate to the synchronization between the IUD log 100 and the actual performance of the refresh operation. The use of the epoch number may help to address this problem by avoiding inclusion of records corresponding to transactions that occurred outside a refresh time range or omitting records corresponding to transactions that actually occurred within a particular refresh time range.

Each base table may have a single epoch number that may be stored as part of the metadata information of the database. Metadata is data stored with the database that relates to the organizational structure and operation of the database. The epoch number may also be visible as part of the runtime information for the associated table. That information may reside in system memory during execution.

When log entries are created in the IUD log 100 (FIG. 2), the current epoch number may be read from the runtime information of the table and written to the log record. When completed, each entry in the refresh log or IUD log 100 may comprise a record that includes a record identifier (e.g Record 102a), a timestamp (e.g. TS 102b), an update type (e.g. UT 102c), a data element (Data 102d) and an epoch number (E 102e). Embodiments of the present invention may be implemented using additional items or subsets of the items listed above.

For purposes of explaining logging operations in accordance with embodiments of the present invention, consider an exact set of all the log records that are relevant to a materialized view for a given table, T. A given invocation of a refresh operation may be referred to as the table delta or T-delta. The logging to the IUD log may be done automatically as a part of the Insert/Update/Delete operations. Two types of logging may be supported, which may result in two types of records in the IUD log. The first type of record relates to IUD logging operations on single rows where each row in the base table is identified by a primary key value. A primary key is an attribute or combination of attributes that, by itself, guarantees the uniqueness of each table row. The second type of record relates to the logging of new ranges in the primary key that result from bulk inserts. A new range is a range in the primary key that was empty of data before the bulk insert happened. The new range is typically locked during the insert.

Range logging may be introduced to the system to optimize the logging time and space requirements. To reproduce the logging information from a range in the IUD log, the range and the table may be joined. This join reflects the current stage of the data in the table and, therefore, does not always reproduce the correct information. The creation and use of an IUD log to resolve conflicts is now explained with reference to FIG. 3.

FIG. 3 is a block diagram showing a system that may perform logging and conflict resolution in accordance with embodiments of the present invention. The diagram shown in FIG. 3 is generally referred to by the reference numeral 120. A system 122 is adapted to perform logging operations and conflict resolution in accordance with embodiments of the present invention. The system 122 may operate in conjunction with a database program and may comprise a portion of such a program.

In the normal course of operation, a base or underlying table 128 may be updated when users perform IUD operations, as illustrated in FIG. 3. A materialized view 130 is based, at least in part, on the underlying table 128. Accordingly, changes to the underlying table 128 may have an impact on the materialized view 130. A logging mechanism 124 receives UD information as the underlying table 128 is changed. The logging mechanism 124 employs the IUD information to create an IUD update log 100, as described in FIG. 2. A refresh manager 126 may be employed to periodically refresh the materialized view 130 based on the changes to the underlying table 128.

The refresh manager may obtain information from the update log 100, as shown in FIG. 3. Those of ordinary skill in the art will appreciate that the refresh manager 126 may also receive information from the underlying table itself. For example, information from the underlying table 128 may be required by the refresh manager 126 in the case of an entry corresponding to a range in the update log 100. A range entry would not typically include the actual data stored to the underlying table 128, so that data would need to be obtained from the underlying table 128 itself. When performing refresh operations on the materialized view 130, the refresh manager 126 may resolve conflicts introduced by range logging, as fully explained below.

Two separate types of logging correctness issues may require resolution. The first issue relates to conflicts between the range records. Ranges may overlap totally or partially. This conflict may happen, for example, if a user performs a bulk insert that is range-logged, then deletes a part of inserted data and performs a new bulk insert (that is also range-logged) in an overlapping area (in place of deleted data). Resolving conflicts between ranges is vital for correctness, to avoid multiple contribution to materialized views. This is an interval intersection analysis problem.

The second issue relates to conflicts between the single-row records and the range records (also called cross-type duplicates). This conflict can happen when a part of data that is inserted in bulk (and range-logged) is updated before the next invocation of refresh. Single-row records store copies of affected rows, whereas range records keep pointers into the table. Therefore, if a single-row record is logically “covered” by a range, it should not be applied, because the correct “version” of the data will be reproduced by a join between the range and the table. A double application (of the single-row record and the range) would result in duplicate contribution to materialized zed views. Therefore, the result will be incorrect.

Two algorithms are described below. The first relates to ranges conflict analysis. The second relates to range operation and single operation conflict analysis. Every time a deferred materialized view is refreshed, a new epoch may be set for all its underlying base tables. As set forth above, the epoch value is an attribute of the base table (T.CURRENT_EPOCH). At the beginning of a refresh operation, each base table is locked, the epoch (T.CURRENT_EPOCH) is set and then the lock is released. The lock during the epoch setting guarantees that values from the same transaction will belong to the same epoch. The use of epochs may be implemented in multiple ways. For example, the epoch number may be the timestamp taken during the table lock period in the beginning of the refresh or it may be any other ever-increasing number. All the underlying base table log records that have appeared between two consecutive invocations of refresh of materialized views on that base table have the same epoch.

Every deferred materialized view maintains a vector of current epochs in the metadata area, one value per each base table. For a materialized view (“MV”) that is defined on a base table T, the value MV.EPOCH [T] stands for the first epoch that was not applied to MV in T-log (i.e., the next time this materialized view will be refreshed, the T-delta computation for it should involve only those log records in T-log that have MV.EPOCH[T]<=Log_Record.EPOCH<T.CURRENT_EPOCH).

The range conflict analysis algorithm may rewrite the ranges so that they contain no overlapping ranges, but with range semantics preserved. In order to achieve this, ranges can be deleted, split, or resized.

A first axiom relating to conflict resolution may be stated as follows: if two ranges overlap, the conflict resolution is always in the favor of the younger range (i.e., the one with a greater timestamp). In other words, the range that has been logged earlier must be changed (deleted, split, or resized) to resolve the overlap, whereas the range which has been logged later must remain intact.

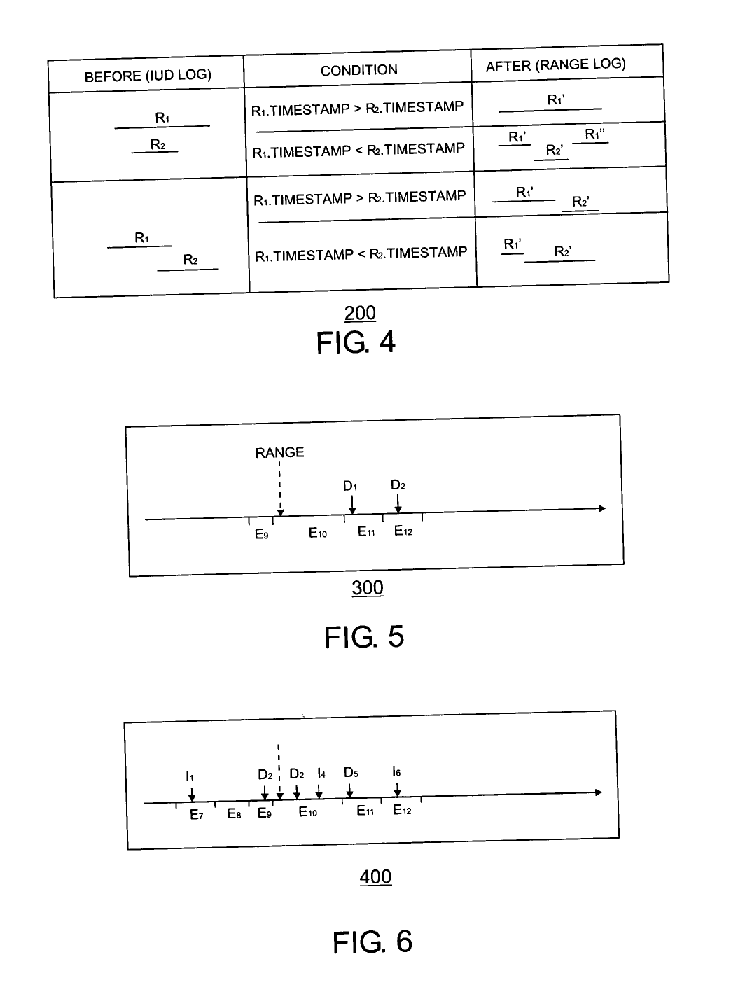

The proof of the first axiom is easiest for two ranges that belong to different epochs. The range with the greater epoch value can be observed alone by some materialized view, but not vice versa. Hence, the range from the smaller epoch is at a disadvantage. The same principle also holds for two overlapping ranges that belong to the same epoch. Confilct resolution rules in accordance with embodiments of the present invention are explained below with reference to FIG. 4.

FIG. 4 is a block diagram that illustrates conflict resolution rules in accordance with embodiments of the present invention. The diagram is generally referred to by the reference numeral 200. The first example shown in FIG. 4 relates to the case when one range is contained entirely within another range. This situation is depicted in the top left column, where R₂ is entirely covered by R₁. The resulting conflict adjusted range log is depicted in the right column of FIG. 3 for the case where the timestamp of R₁ is greater than R₂ (first row of the right hand column) and the case where the timestamp for R₁ is less than the timestamp for R₂ (second row of the right hand column). When the timestamp of R₁ is greater than the timestamp for R₂, the resulting range log (R₁′) comprises the original range R₁. When the timestamp of R₁ is less than the timestamp for R₂, the resulting range log comprises R₁′, R₂′ and R₁″.

The lower row of the left hand column of FIG. 4 illustrates a case in which two ranges partially overlap. The two lower rows of the right hand column show the resulting range log components R₁′ and R₂′, respectively, for cases in which the timestamp of R₁ is greater than the timestamp of R₂ (third row of right hand column) and in which the timestamp of R₁ is less than the timestamp for R₂.

Following the range analysis, a range can be split into a set of subsets or fragments. Fragments produced by the range analysis can be open-ended (on bottom, top, or both). Additionally, the set can also be empty if the particular range is fully dominated by ranges with more recent timestamps.

Next, the issue of range operation and single operation conflict analysis will be discussed. The logging conflict that is relevant to this discussion is the conflict between the single-row records and the range records (also called cross-type duplicates). This conflict can happen, for example, when a part of data that is inserted in a bulk operation (and range-logged) is updated before the next invocation of the refresh operation.

Consider the case of a single log record S (that represents an Insert/Update/Delete operation) that has a primary key value in the same range as the primary key values of a log range record R. A primary key is an attribute or combination of attributes that, by itself, guarantees the uniqueness of each table row. With respect to the following discussion, a beginning range is denoted as BR and an ending range is denoted as ER. Any single row operation record in the log is denoted as S. Any range operation record in the log is denoted as R. A primary key value of any operation is denoted as PKey.

If a single record S (that represents Insert/Update/Delete operation) has: BR.PKey<=S.PKey<=ER.Pkey, we say that record S is covered by the range. If a range covers a single-row record S, and was inserted before the operation described by S happened, it is said to screen S. A comparison between the boundaries of the range with the primary key value of the record tells whether the range covers the record. An additional comparison between the timestamps of the range and the single record tells whether the range screens the record.

Every materialized view that observes both the range and the screened record S must not apply S. This is because S did not contribute to the materialized view before the range, therefore its contribution is already counted by the join between the range and the base table. For example, if the range is followed by a deletion (and no more log record that relates to the same primary key), then the join will return a “hole” in the place of the primary key value. If, however, the range is followed by an insert operation (which means that the range did not include primary key described by the insert operation), the join will return the up-to-date data from the table. The issue of duplicate elimination with ranges is illustrated below with reference to FIG. 5.

FIG. 5 is a schematic diagram that illustrates a first example of duplicate elimination with ranges in accordance with embodiments of the present invention. The diagram is generally referred to by the reference numeral 300.

Every materialized view that has observed the range but not the screened record should take the record into account and apply it to the underlying table. Suppose that a first materialized view (MV₁) observes the log from epoch 9 (E₉) whereas a second materialized view (MV₂) observes the log from epoch 11 (E₁₁). Then, MV₁ must apply only the range but not the records screened by it, but MV₂ must apply both D₁ and I₂. A second example of duplicate elimination with ranges is discussed below with respect to FIG. 6.

FIG. 6 is a schematic diagram that illustrates a second example of duplicate elimination with ranges in accordance with embodiments of the present invention. The diagram is generally referred to by the reference numeral 400. In the example shown in FIG. 6, suppose that MV, observes the log from epoch 7 (E₇), MV₂ observes the log from epoch 10 (E₁₀), and third materialized view (MV₃) observes the log from epoch 11 (E₁₁). Then MV₁ must apply I₁, D₂ and the range, MV₂ must apply the range only, and MV₃ must apply D₅ and I₆.

These examples demonstrate that different materialized views apply the single-row log records selectively. Therefore, the log records that are irrelevant for some materialized views cannot be just deleted from the log, because the other materialized views might need them. Therefore, a solution is to mark the range-covered records in the way that allows selective treatment by each refresh operation. The design and correctness proof of ignore marks appears below.

A duplicate single-row record can be either irrelevant for every materialized view on the table, or for a part of the materialized views on it. The following axioms two and three discriminate between the two cases.

Axiom 2: if the latest screening range belongs to the same epoch as the single-row record, the record is irrelevant for any materialized view. In support of axiom 2, it is submitted that every materialized view observes the log on epoch boundary, hence no materialized view can observe the record separately from the range. The resolution is that the record can be deleted from the IUD log.

Axiom 3: if the single-row record belongs to epoch E, and the latest screening range belongs to epoch E′<E, then the record is irrelevant for each materialized view that fulfils MV.EPOCH[T]<=E′ and not irrelevant for each materialized view that fulfils MV.EPOCH[T]>E′. In support of axiom 3, it is submitted that the first type of materialized view observes the range, whereas the second type does not. The resolution is that the record will be marked using the IGNORE column: IGNORE←E′. Later on, the refresh for a specific materialized view will filter the single-row records for which IGNORE>=MV.EPOCH[T] out from the log. Intuitively, the higher the IGNORE mark is, the less materialized views can apply the record. The default for the IGNORE column is 0, which means that a new (and therefore unmarked) log record is always relevant.

Referring again to the example set forth in FIG. 6, the records D₃ and I₄ must be deleted, whereas D₅ and I₆ must be marked: D₅.IGNORE=I₆. IGNORE=E₁₀. Recalling that MV₂.EPOCH[T]=E₁₀ and MV₃.EPOCH[T]=E₁₁, we get that MV₃ will apply D₅ and I₆ whereas MV₂ will not.

An ignore indication, which may be contained in the update type field of an IUD log, may receive a new value only if it already does not have a higher value. Because a record that is not deleted during the resolution can be only screened by ranges in smaller epochs, its IGNORE value is set only once. This is because some invocation of this algorithm that starts from a smaller epoch cannot discover a range that can give it a higher mark.

The following discussion relates to implementation of the IUD-log primary key. Assume EPOCH represents the epoch for single-row log records and (-epoch) represent range log records. Assume T_PKey1 through T_PKeyn represent the primary key columns (begin range for range record) of the original table. TIMESTAMP represents the logging operation timestamp. Let T_PKey denote the primary key columns of the base table. The primary key of the IUD-log may consist of the following columns, in the following order: EPOCH, T_PKey, TIMESTAMP. Notice that for range records, the EPOCH←(-epoch) and therefore ranges and single-rows that are stored in the log can be scanned separately.

With respect to the implementation of a range conflict analysis algorithm, range conflict analysis may be performed in a single scan on the relevant ranges in the log. The ranges are read in the beginning range value order. For scan of ranges (without actual sorting of the log by (T_PKey, TIMESTAMP)), we exploit the fact that inside each single epoch, the IUD-log records an ordered by (T_PKey, TIMESTAMP). Hence, sorting can be avoided and the required order can be achieved by activating merge-union on the ordered data in the different epochs.

The conflict analysis is typically done in the memory and the range is considered active and is typically kept in the memory only as long as its end range value is smaller or equal to the last begin range value read from the log. When a range becomes not active the result ranges are flashed to the log.

With respect to the implementation of a range operation and single operation conflict analysis, the cross-type resolution statements are performed for each range during range conflict analysis before the flash of the result to the log. The duplicate resolution rules imply two invariants for the resolution of cross-type duplicates of a range R. Every single-row record S within the boundaries of the range in the same epoch that fulfils S.TIMESTAMP>R.TIMESTAMP must be deleted (this is an efficient way to perform a single range delete per range). Every single-row record S within the range's boundaries in the greater epoch that fulfils S. IGNORE<R.EPOCH (i.e., is not screened by a later range already) must receive S.IGNORE←R.EPOCH (this is an efficient single range update per range per epoch).

Thus, embodiments of the present invention facilitate the use of automatic range logging to optimize the logging time and space requirements. The range logging concept is expanded to include key sequenced tables as well as entry sequenced tables. In key sequenced tables, inserts are not necessarily append operations, and may interleave with existing table rows. In range logging operations that are done only in append mode, the correctness issues are simpler. In append mode, conflicts between ranges are not possible and single operations may appear only after the insert range operations. This invention resolves correctness problems that are introduced when automatic range logging is allowed for the general case and not only in append mode.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system, comprising:
a materialized view that is derived at least in part from a table;
a logging mechanism that maintains a refresh log, the refresh log containing a first range and a second range that at least partially overlap, the first range and the second range each having a timestamp associated therewith; and
a refresh manager that resolves conflicts between the first range and the second range that at least partially overlap by selecting portions of the first range and the second range that have the more recent timestamp and applying the selected portions of the first range and the second range to the materialized view.

2. The system set forth in claim 1, wherein the refresh log comprises a plurality of entries, each of the entries comprising an epoch identifier.

3. The system set forth in claim 2, wherein the epoch identifier is defined to correspond to changes that have been made to the table since a previous refresh operation on the materialized view.

4. The system set forth in claim 1, wherein a plurality of materialized views are derived at least in part from the table.

5. A system, comprising:
a materialized view that is derived at least in part from a table;
a logging mechanism that maintains a refresh log, the refresh log containing a range and a single-row entry, the range and the single row entry each having a timestamp associated therewith; and
a refresh manager that resolves conflicts between the range and the single-row entry by ignoring the single-row entry if the single-row entry is part of the range and if the single-row entry has the more recent timestamp and by applying the single-row entry to the materialized view if the single-row entry is not part of the range or if the range has the more recent timestamp.

6. The system set forth in claim 5, wherein the refresh log comprises a plurality of entries, each of the entries comprising an epoch identifier.

7. The system set forth in claim 6, wherein the epoch identifier is defined to correspond to changes that have been made to the table since a previous refresh operation on the materialized view.

8. The system set forth in claim 7, wherein the single-row record belongs to an epoch E, a latest screening range belongs to an epoch E′<E, and the refresh manager is adapted to ignore the single-row record for a materialized view that fulfils MV.EPOCH[T]<=E′ and to apply the single-row record to a materialized view that fulfils MV.EPOCH[T]>E′.

9. The system set forth in claim 5, wherein a plurality of materialized views are derived at least in part from the table.

10. A method, comprising:
deriving a materialized view at least in part from a table;
storing a first range and a second range that at least partially overlap in a refresh log;
associating a timestamp with the first range and the second range in the refresh log; and
resolving conflicts between the first range and the second range in the portion that overlaps by applying a portion of either the first range or the second range that has the more recent timestamp to the materialized view.

11. The method for performing conflict resolution set forth in claim 10, comprising creating a plurality of records in the refresh log and storing an epoch identifier in each of the records.

12. The method for performing conflict resolution set forth in claim 11, comprising defining the epoch identifier to correspond to changes that have been made to the table since a previous refresh operation on the table.

13. The method for performing conflict resolution set forth in claim 10, comprising deriving a plurality of materialized views at least in part from the table.

14. A method, comprising:
deriving a materialized view at least in part from a table;
storing a range and a single-row entry in a refresh log, the range and the single-row entry each having a timestamp associated therewith;
ignoring the single-row entry if the single-row entry is part of the range and if the single-row entry has the more recent timestamp; and
applying the single-row entry to the materialized view if the single-row entry is not part of the range or if the range has the more recent timestamp.

15. The method set forth in claim 14, comprising storing a plurality of entries in the refresh log, each of the plurality of entries comprising an epoch identifier.

16. The method set forth in claim 15, comprising defining the epoch identifier to correspond to changes that have been made to the table since a previous refresh operation on the materialized view.

17. The method set forth in claim 16, wherein the single-row record belongs to an epoch E, a latest screening range belongs to an epoch E′<E, the method comprising:
ignoring the single-row record for a materialized view that fulfils MV.EPOCH[T]<=E′; and
applying the single-row record to a materialized view that fulfils MV.EPOCH[T]>E′.

18. The method set forth in claim 14, comprising deriving a plurality of materialized views at least in part from the table.

19. A computer program, comprising:
a machine readable medium;
a logging mechanism stored on the machine readable medium, the logging mechanism being adapted to create a refresh log that containins a first range and a second range that at least partially overlap, the first range and the second range each having a timestamp associated therewith; and
a refresh manager stored on the machine readable medium, the refresh manager being adapted to resolve conflicts between the first range and the second range that at least partially overlap by selecting portions of the first range and the second range that have the more recent timestamp and applying the selected portions of the first range and the second range to the materialized view.

20. The computer program set forth in claim 19, wherein the refresh log comprises a plurality of entries, each of the entries comprising an epoch identifier.

21. The computer program set forth in claim 20, wherein the epoch identifier is defined to correspond to changes that have been made to the table since a previous refresh operation on any materialized view that is derived at least in part from the table.
